(19) United States
(12) Patent Application Publication
(10) Pub. No.: US 2008/0136787 A1
(43) Pub. Date: Jun. 12, 2008

(54) Touchpad having Single Layer Layout

(76) Inventors: I-HAU YEH, Hsin-Chu City (TW); Wen-Kai Lee, Kaohsiung City (TW)

Correspondence Address: HDSL, 4331 STEVENS BATTLE LANE, FAIRFAX, VA, 22033, US

(21) Appl. No.: 11/855,266

(22) Filed: Sep. 14, 2007

Related U.S. Application Data
(60) Provisional application No. 60/869,547, filed on Dec. 11, 2006.

(51) Int. Cl. G06F 3/041

(52) U.S. Cl. 345/173

(57) ABSTRACT

A touchpad has a substrate; and a single trace layer formed on the substrate. The single trace layer has a single trace layer including rows of conductive traces. Each conductive trace has a gradual change resistance according to a distance far away from one end.

This application is a divisional application of U.S. patent application Ser. No. 60/869,547, filed on Dec. 11, 2006.

### BACKGROUND

Capacitive touch sensing devices (touchpads) are currently known in the art and are available from several manufacturers. The principle advantage of capacitive touch technology is sensitivity to fingers. Only very light contact is required to accurately detect the position of a finger on the pad. This feature makes capacitive touch sensors especially suitable as computer pointing devices.

Capacitive sensors have, so far, been limited to detecting conductive objects which create a large area of contact on the pad and have sufficient capacitance to be detected (for example, human fingers). Objects which are either small or not conductive are difficult to detect capacitively because they have very little capacitance. Thus, a plastic stylus or pen cannot be reliably and accurately detected by existing capacitive sensors. This limitation has excluded capacitive touch sensors from applications, such as graphics tablets, which may require pen input.

A typical capacitive touch pad 10 (as shown in FIGS. 1 and 2) has a rigid substrate (not labeled) having first and second opposing faces; an X-trace layer 12 having a plurality of first parallel conductive traces 16 running in a first direction, said first parallel sensing conductive traces 16 lying in a plane parallel to said first face of said substrate, said X-trace layer 12 disposed on said first face of said substrate; a Y-trace layer 14 having a plurality of second parallel sensing conductive traces 18 running in a second direction orthogonal to said first direction, said second parallel sensing conductive traces 18 lying in a plane parallel to said second face of said substrate, said Y-trace layer 14 disposed on said second face of said substrate; a layer of compliant material (not shown) disposed said substrate; a layer of conducting material (not shown) disposed on an upper surface of said layer of compliant material; and a protective layer (not shown) disposed on an upper surface of said layer of conducting material.

When a finger presses on the surface of capacitive touchpad sensor, the contact of a finger or a pen point on a capacitive touch panel will create a capacitance change. According to the capacitor change, the X-coordinate and the Y-coordinate of the contact point can be calculated. Then, the instruction corresponding to the contact point is sent out. The closer proximity of conductive layer will increase the capacitance measured by the sensor matrix, and appear as a contact signal. The contact signals from the sensor matrix having the X-trace layer 12 and the Y-trace layer 14 can clearly define the location of the contact. First and second conductive traces 16, 18 and may typically be formed by patterning and etching copper clad circuit board material as is well known in the art, or by equivalent known methods. The copper has a lower resistance. Thus, the resistances difference between a beginning end of one trace and a tail end of the trace is nearly zero, and energy waste is lower.

### BRIEF SUMMARY

An example touchpad has a substrate; and a single trace layer formed on the substrate. The single trace layer has a single trace layer comprising rows of conductive traces. Each conductive trace has a resistance increasing or decreasing according to a distance far away from one end.

Another example touchpad has a substrate; and a single trace layer formed on the substrate. The single trace layer has a single trace layer including rows of conductive traces. Each conductive trace has a gradual change resistance according to a distance far away from one end.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic plan view of a conventional touchpad.

FIG. 2 is a schematic cross-sectional view of the touchpad of FIG. 1.

FIG. 3 is a schematic plan view of a touchpad according to a first embodiment of the present invention, which has rows of conductive traces.

FIG. 4 is a schematic view showing each trace having a resistance stably increasing according to a distance far away from a beginning cell of the touchpad of FIG. 3.

FIG. 5 is a schematic plan view of another touchpad according to a second embodiment of the present invention, which has rows of conductive traces.

FIG. 6 is a schematic view showing different detected energy distribution of two adjacent conductive traces of the touchpad of FIG. 5.

FIG. 7 is a schematic plan view of a further another touchpad according to a third embodiment of the present invention, which has rows of conductive traces.

FIGS. 8 and 9 respectively show detected energy change when different sized fingers touch a same position of the touchpad of FIG. 7.

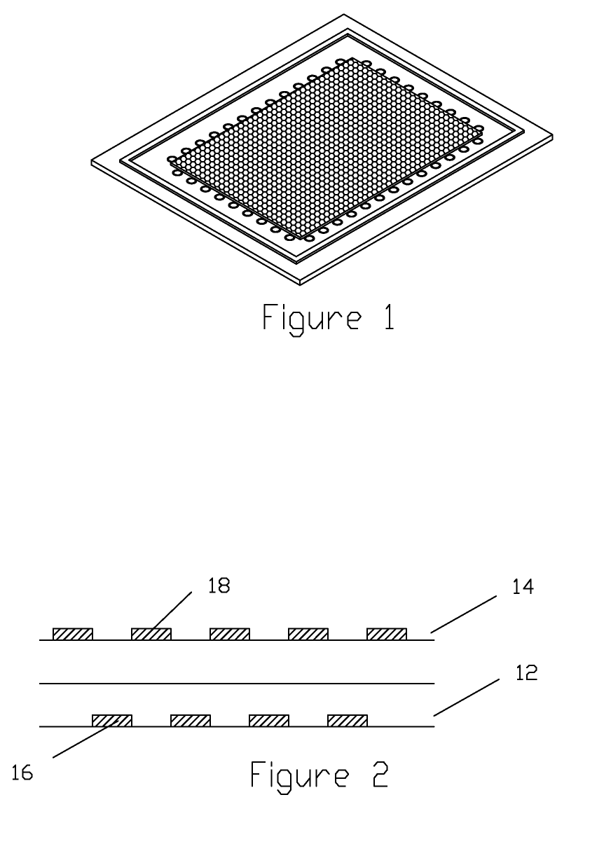

### DETAILED DESCRIPTION

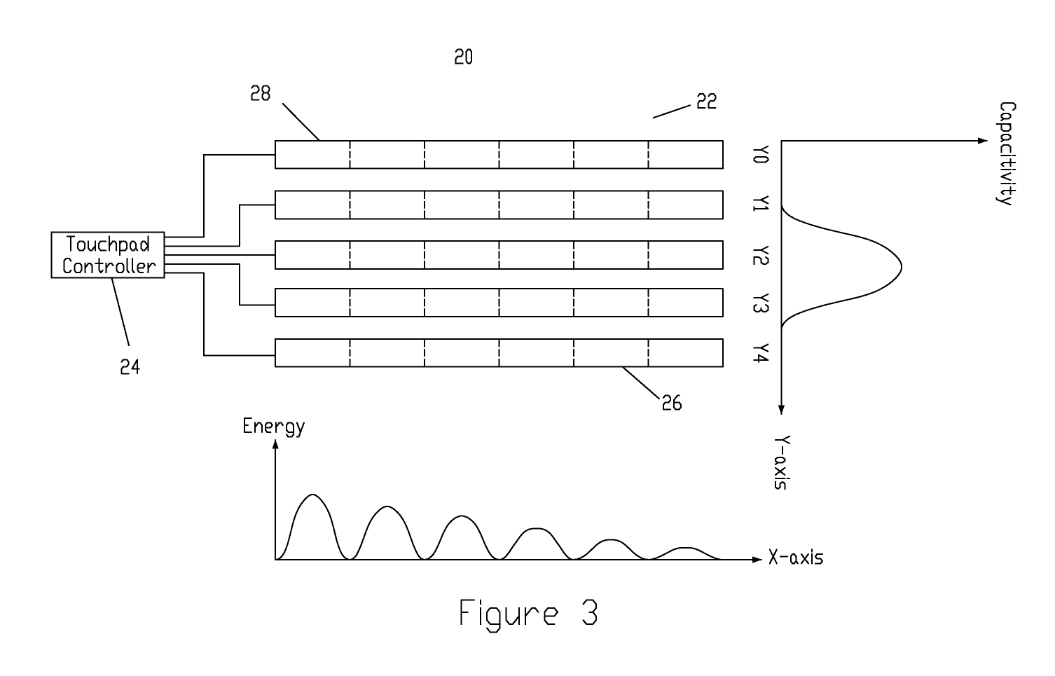

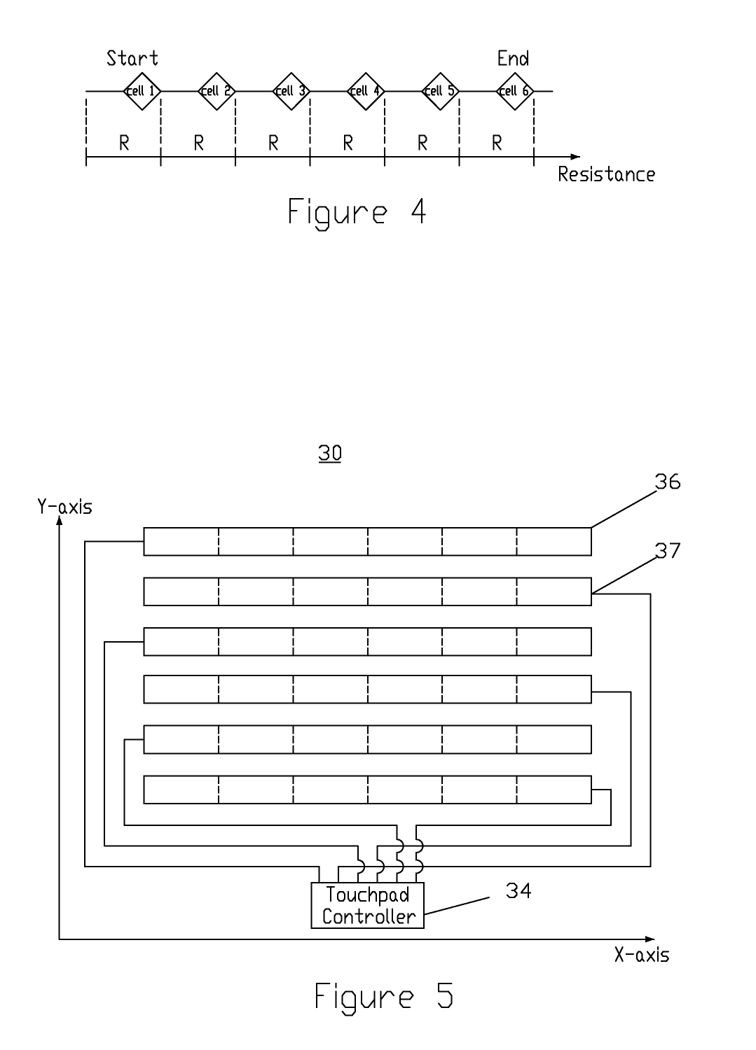

As shown in FIGS. 3 and 4, a touchpad 20 according to a first embodiment of the present invention has a substrate (not shown), a single trace layer 22 formed on the substrate, and a touchpad controller 24 connecting the trace layer 22. The single trace layer 22 has rows of conductive traces 26 extending along horizontal direction. Each conductive trace 26 has number n cells 28 serial connecting together, a beginning cell 28 connecting with the touchpad controller 24. The conductive trace 26 is made from a material having a resistance stably increasing according to a distance far away from a beginning cell 28. The resistances for each cell 28 follows the following function (1):

Rn=nR (1)

Wherein Rn means the resistances of the number n cell, n is a natural number, and R is the resistance of the beginning cell. The time constant for each conductive trace follows the following function (2):

T=R*C+2R*C+3R*C+ . . . +(n−1)R*C+nR*C=n*(n+1)*R*C/2 (2)

Wherein T means the time constant, C is the capacitance of the conductive trace.

When a finger or a pen touches the surface of the touchpad 20, the contact of a finger or a pen point on the touchpad 20 creates a capacitance change measured by the single trace layer 22. Thus, the touchpad controller 24 can clearly detect the contacted conductive branch 26. At the same time, the time constant for the conductive trace 26 also increases following the function (3):

T=R*C+2R*C+3R*C+ . . . +iR*(C+ΔC)+(n−1)R*C+nR*C=n*(n+1)*R*C/2+iR*ΔC (3)

Wherein iR (1≦i≦n) means the resistance of the contact cell 28 on the conductive trace 26 and ΔC means the increasing capacitance from the finger. When the touchpad controller 24 detects the changed time constant of the contacted conductive trace 26, the controller 24 can clearly detect the concretely contacting position on the contacted conductive branch. Therefore, the contact position of the finger can be determined by the single trace layer.

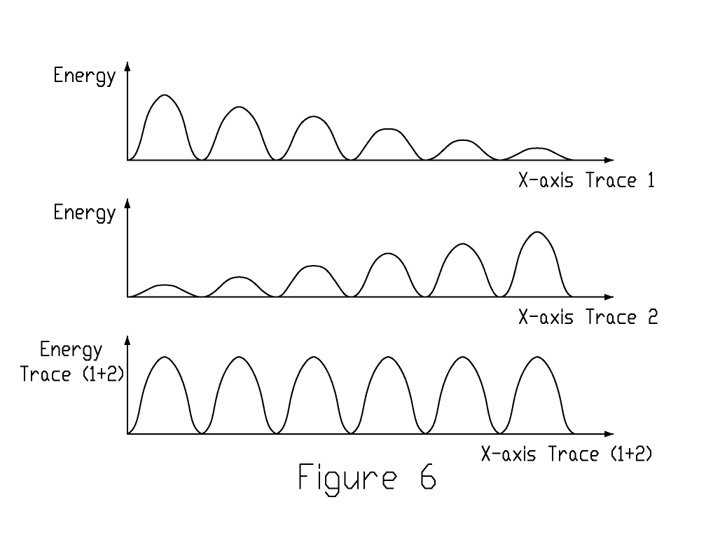

As shown in FIG. 5, an another touchpad 30 according a second embodiment of the present invention has a structure same to that of the first embodiment except that beginning ends connected to a touchpad 34 of odd row conductive traces 36 are disposed at a left side of the touchpad 30 and beginning ends connected to a touchpad 34 of even row conductive traces 37 are disposed at a right side of the touchpad 30. That is, the beginning end of the odd row conductive trace 36 is corresponding to tail ends of the adjacent even row conductive traces 37, and the beginning end of the even row conductive trace 37 is corresponding to tail ends of the adjacent odd row conductive traces 36. Because the energy at the beginning ends is highest and the energy at the tail ends is lowest, thus, the add of the detected energy of two adjacent conductive traces 36, 37 is constant, which can effectively avoid noise (as shown in FIG. 6).

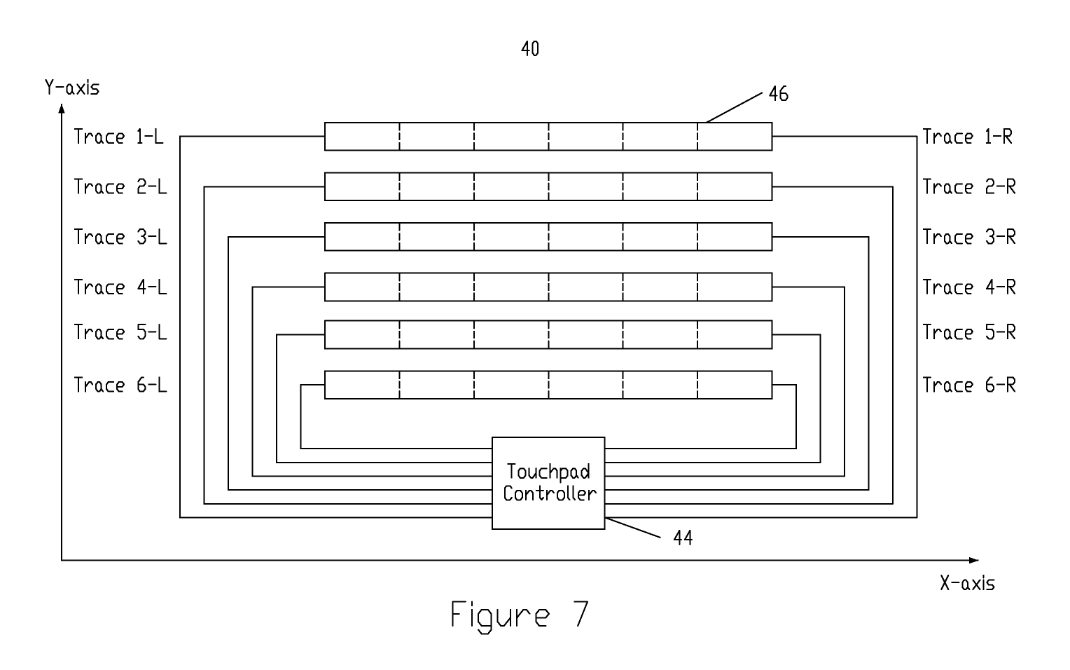

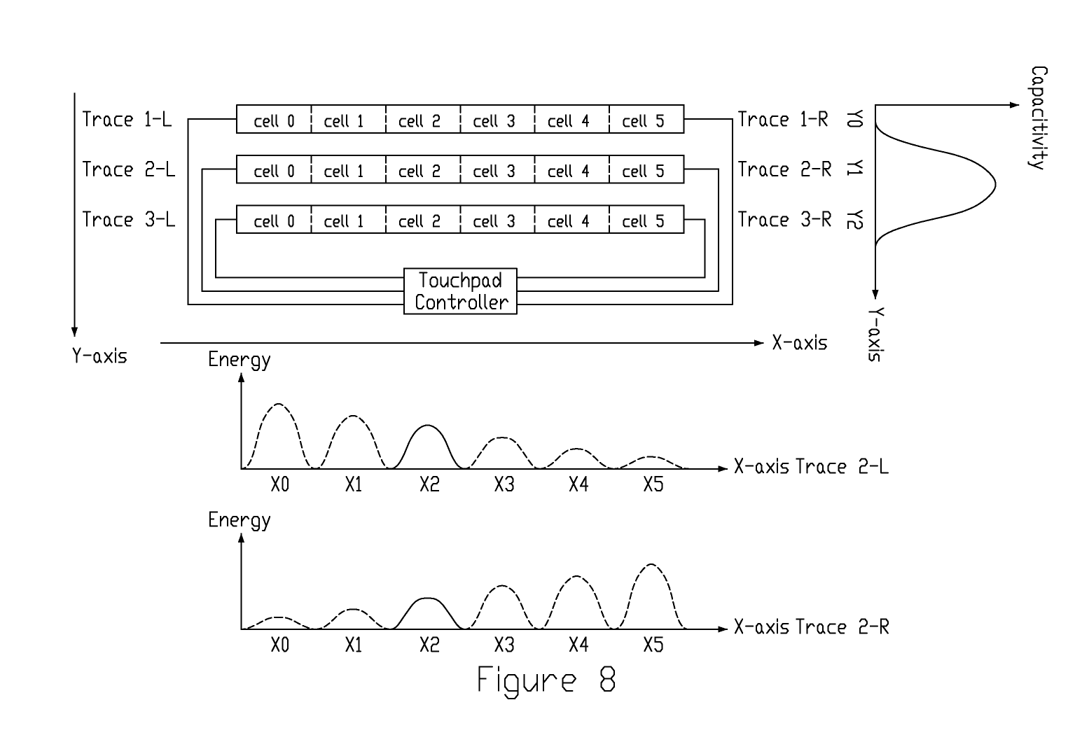

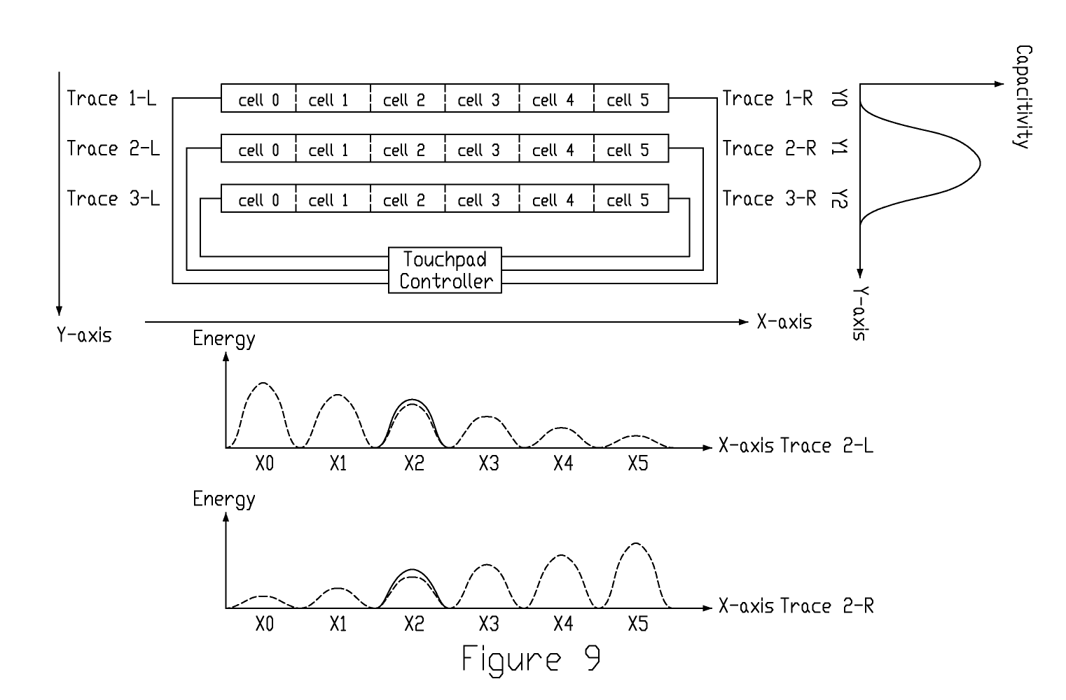

As shown in FIG. 7, a further another touchpad 40 according a third embodiment of the present invention has a structure same to that of the first embodiment except that a beginning end and a tail end of each conductive trace 46 are all connected to a touchpad controller 44. In operation, one conductive trace 46 can be scanned twice, but from two different scanning ends, one being the beginning end and another being the tail end of the conductive trace 46. Thus, the position tolerance influenced by the pressure, contact area or humidity of the finger or other touch pens can be minimized. Therefore, a reliably and accurately detection can be attained. For example, as shown in FIGS. 8 and 9, when two different sized fingers respective touch a same position, corresponding to the second cell of the second trace, of the touchpad 40, the detected maximal capacitance is positioned at the second cell of the second trace. However, the detected maximal energy by the touchpad controller is different because two different contact areas. Thus, a controlling method of just scanning one end of a conductive trace can attain two different maximal energies and determines two different touch positions. But, the controlling method of the touchpad 40, i.e. respectively scanning one conductive trace 46 from two ends thereof, can effectively resolve the above described questions and attain an accurate detection results.

The conductive traces having geometric proportion increasing resistances can be made from all kinds of conductive material, such as Indium-Tin Oxide (ITO), flexible printed circuit (FPC) or printed circuit board (PCB) or Membrane. When the conductive traces are made from ITO, the conductive traces having increasing resistance can be attained by controlling the width of each cell of the trace. When the conductive traces are made from PCB, the conductive traces having increasing resistance can be attained by coating different resistance at each cell of the trace. In an alternative embodiment, the conductive traces also can have geometric proportion decreasing resistance, which has similar operation theory.

The touchpad utilizes the single trace layer having geometric proportion increasing or decreasing resistances to realize detecting single dimension coordinate or two dimension coordinate. In addition the touchpad also has a simple layout and lower cost.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touchpad comprising:
a substrate; and
a single trace layer formed on the substrate, which comprises a single trace layer comprising rows of conductive traces;
wherein each conductive trace has a resistance increasing or decreasing according to a distance far away from one end.

2. The touchpad as claimed in claim 1, wherein the conductive traces have geometric proportion increasing or decreasing resistances.

3. The touchpad as claimed in claim 1, wherein the conductive traces have inequality proportion increasing or decreasing resistances.

4. The touchpad as claimed in claim 1, further comprising a touchpad controller connected with the single trace layer.

5. The touchpad as claimed in claim 4, wherein the touchpad controller is connected to a beginning end or a tail end of each conductive trace.

6. The touchpad as claimed in claim 5, wherein each conductive trace is scanned by the touchpad controller from the beginning end or the tail end thereof.

7. The touchpad as claimed in claim 4, wherein the touchpad controller is connected to a beginning end and a tail end of each conductive trace.

8. The touchpad as claimed in claim 7, wherein each conductive trace is scanned by the touchpad controller from the beginning end and the tail end thereof, respectively.

9. The touchpad as claimed in claim 4, wherein two connecting ends of the touchpad controller with two adjacent conductive traces are respectively disposed at two opposite sides of the touchpad.

10. The touchpad as claimed in claim 1, wherein the conductive traces can be made from Indium-Tin Oxide (ITO), flexible printed circuit (FPC) or printed circuit board (PCB) or Membrane.

11. The touchpad as claimed in claim 1, wherein each conductive trace comprises number n cells serial connecting together.

12. The touchpad as claimed in claim 11, wherein the conductive traces having increasing resistance can be attained by controlling the width of each cell of the trace.

13. The touchpad as claimed in claim 11, wherein the conductive traces having increasing resistance can be attained by coating different resistance at each cell of the trace.

14. The touchpad as claimed in claim 1, further comprising a protective overlayer, a compliant material, and a conductive layer.

15. The touchpad as claimed in claim 4, wherein the touchpad controller detects the capacitance change measured by the single trace layer.

16. The touchpad as claimed in claim 4, wherein the touchpad controller detects the energy change or the time constant change produced by increasing or decreasing resistance of each conductive trace.

17. The touchpad as claimed in claim 4, wherein the touchpad controller detects the concrete contact position according to the capacitance change and the energy change, or the capacitance change and the time constant change.

18. A touchpad comprising:
a substrate; and
a single trace layer formed on the substrate, which comprises a single trace layer comprising rows of conductive traces;
wherein each conductive trace has a gradual change resistance according to a distance far away from one end.

19. The touchpad as claimed in claim 1, wherein the rows of conductive traces extend along a predetermined direction.
